(19) United States
(12) Patent Application Publication
(10) Pub. No.: US 2009/0078633 A1
(43) Pub. Date: Mar. 26, 2009

(54) CHROMATOGRAPHIC STATIONARY PHASES

(75) Inventors: Wu Chen, Newark, DE (US); Alan D. Broske, West Chester, PA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Palo Alto, CA (US)

(21) Appl. No.: 11/859,502

(22) Filed: Sep. 21, 2007

(51) Int. Cl. B01D 15/10; C07F 7/08

(52) U.S. Cl. 210/198.2; 556/471

(57) ABSTRACT

A chromatographic stationary phase for use in reversed-phase chromatography. A process for producing a chromatographic stationary phase for use in reversed-phase chromatography, chromatographic stationary phases prepared according to the methods of the current invention, and liquid chromatography columns, which include the stationary phases, are also provided.

### FIELD OF THE INVENTION

The present invention relates to chromatographic stationary phases for use in liquid chromatography. More particularly, the present invention relates to chromatographic stationary phases for use in reversed-phase HPLC.

### BACKGROUND

Chromatography, for example liquid chromatography (LC), gas chromatography (GC), or supercritical fluid chromatography (SFC), is employed in both analytical and preparative methods to separate one or more species, e.g. chemical compounds, present in a carrier phase from the remaining species in the carrier phase. Chromatography is also employed, in a manner independent of separation of chemical species, as a method for analyzing purity of a chemical species, and/or as a means of characterizing a single chemical species. Characterization of a chemical species may comprise data, for example, a retention time for a particular chemical compound, when it is eluted through a particular chromatography column using specified conditions, e.g., carrier phase composition, flow rate, temperature, etc.

The carrier phase, often termed the “mobile phase,” for reversed phase (RP) LC typically comprises water and one or more water-miscible organic solvents, for example, acetonitrile or methanol. The species typically form a solution with the carrier phase. The carrier phase is typically passed through a stationary phase.

The rate at which a particular species in a carrier phase passes through a stationary phase depends upon the affinity of the species for the stationary phase.

Species having a higher affinity for the stationary phase pass through at slower rates relative to species having lower affinity for the stationary phase.

Affinity of a species for a stationary phase results primarily from interaction of the species with chemical groups present on the stationary phase. Chemical groups may be provided on the stationary phase by reacting a surface-modifying reagent with a substrate, such as a silica substrate.

Considerable research has been directed toward new stationary phase compositions for use in chromatography. Exemplary modified silica supports are disclosed in U.S. Pat. Nos. 5,374,755; 6,645,378; and 7,175,913.

There remains, however, a need to provide such stationary phase compositions for chromatography which provide useful separation characteristics for particular types of species mixtures and also for broad application to chromatographic separations.

### SUMMARY OF THE INVENTION

The present invention is directed to a chromatographic stationary phase, which includes an inorganic oxide or porous polymeric support material having bonded thereto, via Si—O bonds, at least one silane of formula I:

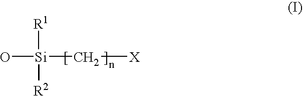

wherein R¹ is a C₈ to C₁₈ hydrocarbyl; R² is a C₁ to C₄ hydrocarbyl; n is 2-3; and X is a polar group.

Also provided is a process for producing a chromatographic stationary phase for use in reversed-phase chromatography by providing an inorganic oxide or porous polymeric support material comprising surface hydroxyl groups; reacting the surface hydroxyl groups with at least one silane coupling agent having a formula:

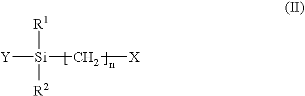

wherein R¹ is a C₈ to C₁₈ hydrocarbyl; R² is a C₁ to C₄ hydrocarbyl; n is 2-3; X is a polar group; Y is halogen, OR³ or NR⁴R⁵, wherein R³ is C₁ to C₃₀ alkyl, and R⁴ and R⁵ are independently hydrogen or C₁ to C₃₀ alkyl; and reacting remaining surface hydroxyl groups with at least one endcapping reagent having a formula selected from the group consisting of formulas III and IV:

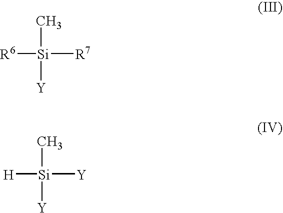

wherein, R⁶ and R⁷ are independently hydrogen or methyl and Y is halogen, OR³, or NR⁴R⁵, wherein R³ is C₁ to C₃₀ alkyl and R⁴ and R⁵ are independently hydrogen or C₁ to C₃₀ alkyl, to provide a functionalized particulate support material.

Chromatographic stationary phases prepared according to the methods of the current invention and liquid chromatography columns, which include the stationary phases, are also provided.

### BRIEF DESCRIPTION OF THE DRAWINGS

FIG. 1 provides chromatograms of: (1) uracil, (2) propanolol, (3) nortiptyline, (4) amitriptyline, and (5) trimipramine on C₁₈-Carbamate silica of the present invention (upper) and on a commercially-available polar embedded phase (lower); and

FIG. 2 provides chromatograms of: (1) uracil, (2) propanolol, (3) nortiptyline, (4) amitriptyline, and (5) trimipramine on C₁₈-Carbamate silica of the present invention (upper) and on C₈-Carbamate silica of the present invention (lower).

### DETAILED DESCRIPTION OF THE INVENTION

The chromatographic stationary phase of the present invention includes an inorganic oxide or porous polymeric support material having bonded thereto, via Si—O bonds, at least one silane of formula I:

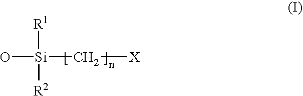

wherein R¹ is a C₈ to C₁₈ hydrocarbyl; R² is a C₁ to C₄ hydrocarbyl; n is 2-3; and X is a polar group.

The C₈ to C₁₈ hydrocarbyl at R¹ protects Si—O—Si bonds in the stationary phase from hydrolysis, making the phase more stable under low pH conditions. As used herein, the term hydrocarbyl means any ligand comprising a straight chain, branched, or cyclic carbon backbone. Further, the ligand may contain one or more unsaturated moieties and in the case of cyclic moieties, may be aryl. In a preferred embodiment, R¹ is C₁₈H₃₇ or C₈H₁₇.

The polar group at X provides exceptional peak shapes for very polar and strong basic compounds. The incorporation of such polar functional groups in an alkyl ligand (e.g. —[CH2]ₙ—, wherein n is 2-3) close to the surface of the inorganic oxide or porous polymeric support material facilitates wetting of the surface and decreases phase collapse. Suitable polar groups include, but are not limited to, amide, urea, sulfonamide, carbamate, hydroxyl, ether, ester, cyano, and ketone. Preferred ether groups include methoxyl and ethoxyl.

The C₁ to C₄ hydrocarbyl of R² is preferably selected from methyl, ethyl, propyl, isopropyl, butyl, and isobutyl.

In a preferred stationary phase of the present invention, R¹ is C₁₈H₃₇, n is 3, and X is carbamate. In another preferred stationary phase, R¹ is C₈H₁₇, n is 3, and X is carbamate. Additional preferred stationary phases include those in which R¹ is C₁₈H₃₇ or C₈H₁₇, n is 3, and X is methoxyethoxyl.

Suitable inorganic oxide support materials include those typically utilized in liquid chromatography, for example, silica, hybrid silica, an example of which is disclosed in U.S. Pat. No. 4,017,528, the contents of which are incorporated herein by reference, alumina, titanium oxide, and zirconium oxide. Suitable porous polymeric materials include, for example, those disclosed in U.S. Pat. No. 6,492,471, the contents of which are incorporated herein by reference. Furthermore, the support can be in any form suitable for use in liquid chromatography. Suitable forms include porous particles, non-porous particles, porous membranes, and porous monoliths, an example of which is disclosed in U.S. Pat. No. 6,210,570 the contents of which are incorporated herein by reference. As used herein, the term “porous” means any chromatographically-suitable degree of porosity. The term “porous particles” also includes superficially porous particles, for example, non-porous particles coated with a porous outer layer.

Also presented is a process for producing a chromatographic stationary phase for use in reversed-phase chromatography by providing an inorganic oxide or porous polymeric support material, which includes surface hydroxyl groups; reacting the surface hydroxyl groups with at least one silane coupling agent having a formula:

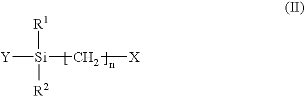

wherein R¹, R², n, X, and Y are as described above; and reacting remaining surface hydroxyl groups with at least one endcapping reagent having a formula selected from formulas III and IV:

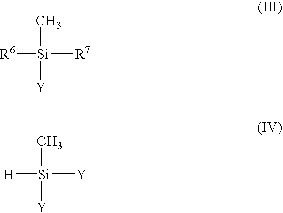

wherein, R⁶ and R⁷ are independently hydrogen or methyl and Y is halogen, OR³, or NR⁴R⁵, wherein R³ is C₁ to C₃₀ alkyl and R⁴ and R⁵ are independently hydrogen or C₁ to C₃₀ alkyl, to provide a functionalized particulate support material. Preferably, Y is selected from —Cl, —NMe₂, and —OEt.

The silane coupling agent used to create the hydrophobic phase may be introduced in any manner commonly known in the art.

Typical methodologies for introducing the hydrophobic phase are described in Silane Coupling Agents: Connecting Across Boundaries, published by Gelest, Inc. (2004), and available at www.gelest.com/company/pdfs/couplingagents.pdf The methods described therein are also useful for introducing the endcapping agent. The current invention does not depend on the manner in which the silane coupling agent is introduced, and it is contemplated that the current invention will be applicable to all conventionally known ways of introducing the silane coupling agent.

The endcapping is done in an inert solvent, such as toluene, tetrahydrofuran or another inert hydrocarbon, under reflux conditions according to methods that are well known in the art. The endcapping agent may be introduced using any silane capable of generating a mono or dimethyl hydrosilyl groups in solution at reflux or in a gas phase reaction since small mono or dimethyl hydrosilanes have low boiling point temperatures.

Chromatographic stationary phases prepared according to the methods of the current invention and liquid chromatography columns, which include the stationary phases, are also provided.

### EXAMPLES

### Example 1

### Preparation of allyl N, N-dimethyl carbamate

Allyl alcohol (60.07 g, 1.03 mol) and potassium hydroxide (87.10 g, 1.55 mol) were added to a 1-L, 2-neck round bottom flask, along with 500 ml of THF. A condenser was attached to the center neck of the flask while an addition funnel was attached to the other neck. Dimethyl carbamyl chloride (85.88 g, 0.80 mol) was added to the addition funnel, and a N₂ line was attached to the opening of the funnel to keep moisture out of the system. While stirring, the dimethyl carbamyl chloride was slowly added, drop-wise, at room temperature. After all was added, the solution was left to stir overnight.

About ½ of the mixture was then transferred to a 1000 ml separatory funnel along with 200 ml of distilled water. The solution was washed twice with 200 ml ether, keeping the organic layers aside. The other half of the mixture was treated the same, keeping the organic layers. Combining all organic, the organic layer was washed twice with 200 ml distilled water. The organic was dried over anhydrous MgSO₄ for 1 hr. The organic solution was filtered to remove the drying agent. The ether was distilled off using a rotary evaporator, leaving behind the carbamate. The carbamate was further purified by vacuum distillation, collecting the fraction at 95° C./˜100 mmHg.

### Example 2

### Preparation of N,N-dimethyl-(chloromethyloctadexylsilylpropyl) carbamate

H₂PtCl₆ (1.09 g, 2.65 mmol) was dissolved in 2 ml CH₃CN and added to a 250 ml, 2-neck round bottom flask along with chloromethyloctadecylsilane (110.18 g, 331 mmol). A condenser was attached to one neck and an addition funnel to the other neck. The allyl N,N-dimethyl carbamate (63.94 g, 496 mmol) was added to the addition funnel, and the system was kept under N₂. While stirring, the reaction was heated to ˜80° C. and the carbamate was slowly added, drop-wise. After a small amount of carbamate was added, the solution turned black and vapors formed. At this point, the addition was temporarily halted. The mixture was left to stir until the vapors dissipated. The remaining carbamate was added at a faster rate, and the solution was left to heat and stir overnight.

The silane was then cleaned using a flash column. A slurry was prepared using florisil in heptane and added to a column. Florisil was pre-dried at 600° C. for 2 hours. The column was attached to one neck of a 2-neck round bottom flask to collect the purified silane, while the other neck was attached to a vacuum pump. About half of the silane was added to 100 ml heptane and then run through the column, using vacuum to expedite the process. An additional amount of heptane was used to rinse any remaining silane on the column. The other half of the silane was cleaned in the same fashion, using new slurry in the column. The cleaned silane-heptane solutions were combined and run through a fresh column once more to remove any remaining solids and impurities. The heptane was evaporated off using a rotary evaporator. The silane was further purified by vacuum distillation, using a high vacuum pump and heat to draw off any heptane and starting materials. The remaining silane was slightly cooled and bottled before the silane solidified.

### Example 3

### Preparation of N,N-dimethyl-(chloromethyloctylsilylpropyl) carbamate

N,N-dimethyl-(chloromethyloctadecylsilylpropyl)carbamate was synthesized using the same procedure as Example 2 except the silane was purified by vacuum distillation at 165-180/0.1° C. mmHg.

### Example 4

### Bonding N,N-dimethyl-(chloromethyloctadecylsilylpropyl) carbamate on silica

Silica (5 μm, 20.25 g, SA=166 m²/g), imidazole (5.52 g, 81.08 mmol), and toluene (110 ml) were added to a 250 ml round bottom flask. A Barrett trap, condenser, and nitrogen line were attached. The system was first purged with nitrogen before starting the refluxing. While stirring and under nitrogen, the slurry was heated to reflux to remove any water. After refluxing, the slurry was allowed to cool below 100° C., and the 30 ml of toluene/water collected in the trap was removed. The Barrett trap and condenser were removed, rinsed with THF, and blown dry with air.

N,N-dimethyl-(chloromethyloctadecylsilylpropyl)-carbamate (34.48 g, 74.7 mmol) was added to the round bottom flask, and the condenser and nitrogen line were attached. The slurry was then left to stir under reflux conditions overnight (18-24 hours). While hot, the slurry was filtered through a fritted funnel of medium porosity (10-20 μm). The silica was washed with 50 ml toluene and 50 ml THF, and then reslurried in 100 ml THF/H₂O (80/20). The slurry was refluxed for 10 min, filtered, washed with 50 ml THF/H₂O (80/20) and 30 ml THF, and reslurried in 100 ml THF/H₂O (80/20). The slurry was refluxed for 10 min, filtered, washed with 50 ml THF/H₂O (80/20) and 50 ml CH₃CN, and reslurried in 100 ml CH₃CN. The slurry was refluxed for 10 min, filtered, and washed with 50 ml CH₃CN. The silica was dried under vacuum at 110° C. for 2 hrs.

### Example 5

### Endcapping C₁₈-Carbamate silica

The above C₁₈-Carbamate silica (10.08 g) prepared according to Example 4 and toluene (70 ml) were added to a 250 ml round bottom flask. A Barrett trap, condenser, and nitrogen line were attached. The system was first purged with nitrogen before starting the refluxing. While stirring and under nitrogen, the slurry was heated to reflux to remove any water. After refluxing, the slurry was allowed to cool below 100° C., and the 30 ml of toluene/water collected in the trap was removed. The Barrett trap and condenser were removed, rinsed with THF, and blown dry with air.

(N,N-dimethylamino)dimethylsilane (4.19 g, 40.59 mmol) was added to the round bottom flask, and a condenser and nitrogen line were attached. The slurry was then left to stir under reflux conditions overnight (18-24 hours). While hot, the silica was filtered through a fritted funnel of medium porosity (10-20 μm). The silica was washed with 2×50 ml toluene and reslurried in 50 ml toluene. The silica was filtered, washed with 50 ml THF, and then reslurried in 50 ml THF. The silica was filtered, washed with 50 ml CH₃CN, and reslurried in 50 ml CH₃CN. The slurry was filtered, washed with CH₃CN, and then air-dried. The silica was dried under vacuum at 110° C. for 2 hrs.

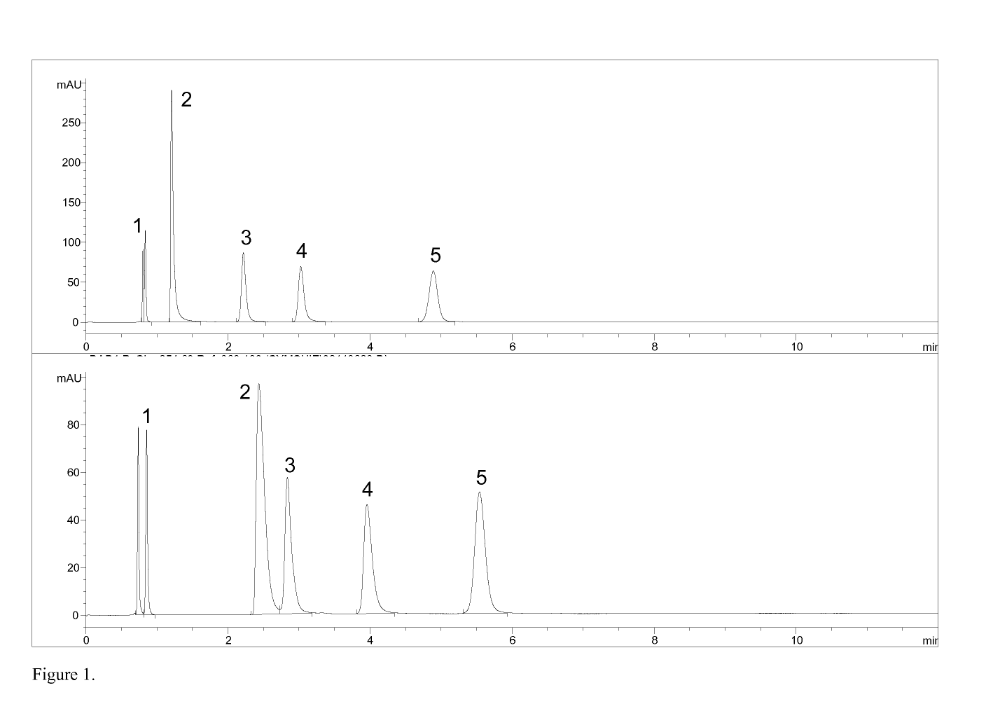

In order to evaluate the selectivity of the C₁₈-Carbamate silica and peak shapes of a variety of strong bases, a mobile phase (40% 20 mM phosphate, pH 7.0, 60% acetonitrile (ACN)) was eluted through a column (4.6×100 mm, 5 μm) packed with the C₁₈-Carbamate silica at a rate of 1 ml/min at 40° C. using a mixture of strong bases (1. uracil as T₀ marker, 2. propranolol, 3. nortiptyline, 4. amitriptyline, 5. trimipramine) as analytes. The mobile phase was then eluted through a column packed with a commercially-available polar embedded phase. FIG. 1 provides a selectivity comparison between the C₁₈-Carbamate silica and the commercially-available polar embedded phase. The upper chromatogram is for the C₁₈-carbamate phase on silica; the lower chromatogram is for the polar embedded phase. The C₁₈-carbamate phase provides different selectivity between Compounds 2 and 3, and also better peak shapes than the commercially-available polar embedded phase.

### Example 6

### Bonding and Endcapping of C₈-Carbamate silica

Bonding N, N-dimethyl-(chloromethyloctylsilylpropyl)carbamate on silica and endcapping was done using the same procedure as Examples 4 and 5, respectively.

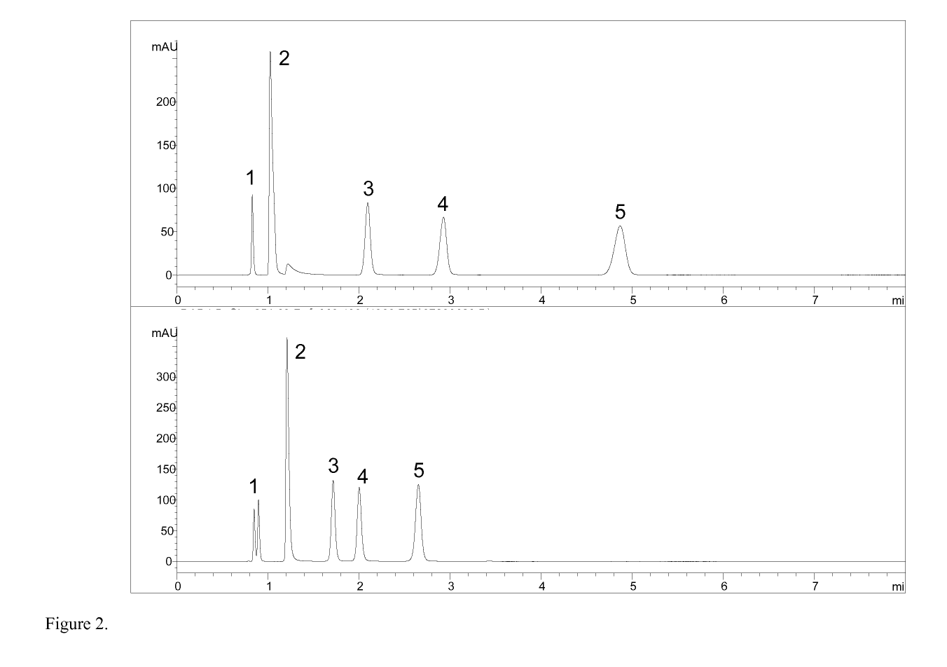

In order to evaluate the selectivity of the C₈-Carbamate silica and peak shapes of a variety of strong bases, a mobile phase (40% 20 mM phosphate, pH 7.0, 60% acetonitrile (ACN)) was eluted through a column (4.6×100 mm, 5 μm) packed with the C₈-Carbamate silica at a rate of 1 ml/min at 40° C. using the same mixture of strong bases as analytes as provided in Example 5. The mobile phase was then eluted through a column packed with the C₈-Carbamate silica prepared according to Examples 4 and 5. FIG. 2 provides a selectivity comparison between the C₈-Carbamate silica and the C₁₈-Carbamate silica. The upper chromatogram is for the C₁₈-carbamate phase on silica; the lower chromatogram is for the C₈-carbamate phase on silica. With short C₈ on the silica, the retention time of the phase becomes shorter. Both phases show excellent peak shapes for strong bases.

### Example 7

### Preparation of Ethylene Glycol Allyl Methyl Ether

To a mixture of NaH (7.2 g) in 200 ml THF was added a mixture of ethylene glycol allyl ether and Me1 in 100 ml THF dropwise at room temperature. The mixture was stirred for 3 hours after addition. 200 ml water was added. Ether (100 ml×2) was used to extract the product. The combined organic layer was dried with MgSO₄. After solvent was removed, the product was distilled at 124-128° C.

### Example 8

### Preparation of chloromethyl(methoxyethoxylpropyl)octadecylsilane

Chloromethyl(methoxyethoxylpropyl)octadecylsilane was prepared from ethylene glycol allyl ether and chloromethyloctadecylsilane according to the procedure of Example 2.

### Example 9

### Bonding and Endcapping chloromethyl(methoxyethoxylpropyl)octadecylsilane on silica

Bonding and endcapping chloromethyl(methoxyethoxylpropyl)octadecylsilane on silica was performed according to the procedures of Examples 4 and 5, respectively.

The present invention has thus been described with reference to specific non-limiting examples. The full scope of the present invention will be apparent from the appended claims.

What is claimed is:

1. A chromatographic stationary phase comprising an inorganic oxide or porous polymeric support material having bonded thereto, via Si—O bonds, at least one silane of formula I: 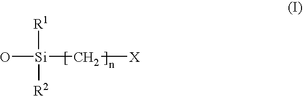
wherein:
R¹ is a C₈ to C₁₈ hydrocarbyl;
R² is a C₁ to C₄ hydrocarbyl;
n is 2-3; and
X is a polar group.

2. The chromatographic stationary phase of claim 1, wherein R¹ is C₁₈H₃₇ or C₈H₁₇.

3. The chromatographic stationary phase of claim 1, wherein R² is selected from the group consisting of methyl, ethyl, propyl, isopropyl, butyl, and isobutyl.

4. The chromatographic stationary phase of claim 1, wherein X is selected from the group consisting of amide, urea, sulfonamide, carbamate, hydroxyl, ether, ester, cyano, and ketone.

5. The chromatographic stationary phase of claim 2, wherein n is 3, and X is carbamate or methoxyethoxyl.

6. The chromatographic stationary phase of claim 1, wherein said inorganic oxide support material is selected from the group consisting of porous particles, non-porous particles, porous membranes, and porous monoliths.

7. The chromatographic stationary phase of claim 1, wherein said inorganic oxide support material is selected from the group consisting of silica, hybrid silica, alumina, titanium oxide, and zirconium oxide.

8. A liquid chromatography column comprising the chromatographic stationary phase of claim 1.

9. A process for producing a chromatographic stationary phase for use in reversed-phase chromatography, comprising:
providing an inorganic oxide or porous polymeric support material comprising surface hydroxyl groups;
reacting the surface hydroxyl groups with at least one silane coupling agent having a formula: 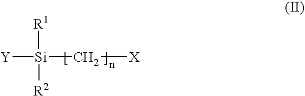
wherein:
R¹ is a C₈ to C₁₈ hydrocarbyl;
R² is a C₁ to C₄ hydrocarbyl;
n is 2-3;
X is a polar group;
Y is halogen, OR³ or NR⁴R⁵, wherein R³ is C₁ to C₃₀ alkyl, and R⁴ and R⁵ are independently hydrogen or C₁ to C₃₀ alkyl; and
reacting remaining surface hydroxyl groups with at least one endcapping reagent having a formula selected from the group consisting of formulas III and IV: 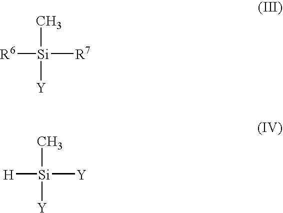
wherein, R⁶ and R are independently hydrogen or methyl and Y is halogen, OR , or NR⁴R⁵, wherein R³ is C₁ to C₃₀ alkyl and R⁴ and R⁵ are independently hydrogen or C₁ to C₃₀ alkyl, to provide a functionalized particulate support material.

10. The process of claim 9, wherein R¹ is C₁₈H₃₇ or C₈H₁₇.

11. The process of claim 9, wherein R² is selected from the group consisting of methyl, ethyl, propyl, isopropyl, butyl, and isobutyl.

12. The process of claim 9, wherein X is selected from the group consisting of amide, urea, sulfonamide, carbamate, hydroxyl, ether, ester, cyano, and ketone.

13. The process of claim 10, wherein n is 3, and X is carbamate or methoxyethoxyl.

14. The process of claim 12, wherein said inorganic oxide support material is selected from the group consisting of porous particles, non-porous particles, porous membranes, and porous monoliths.

15. The process of claim 12, wherein said inorganic oxide support material is selected from the group consisting of silica, hybrid silica, alumina, titanium oxide, and zirconium oxide.

16. A chromatographic stationary phase prepared according to the process of claim 12.

17. A liquid chromatography column comprising the chromatographic stationary phase of claim 1.
